(19) United States
(12) Patent Application Publication
(10) Pub. No.: US 2023/0378705 A1
(43) Pub. Date: Nov. 23, 2023

(54) TERMINAL CRIMPING APPARATUS

(71) Applicant: HIROSE ELECTRIC CO., LTD., Yokohama (JP)

(72) Inventor: Tomohiro Sato, Yokohama (JP)

(21) Appl. No.: 18/362,390

(22) Filed: Jul. 31, 2023

Related U.S. Application Data
(62) Division of application No. 17/954,774, filed on Sep. 28, 2022.

(30) Foreign Application Priority Data
Sep. 30, 2021 (JP) 2021-160568

(51) Int. Cl. H01R 43/048

(52) U.S. Cl. CPC H01R 43/048

(57) ABSTRACT

A terminal crimping apparatus clamps a barrel portion of a terminal between an anvil and a crimper and caulks the barrel portion so as to enclose a core wire of a cable with the barrel portion. The terminal crimping apparatus comprising: a pressing part which is provided adjacent to the crimper side by side, is capable of separating from and approaching to the cable by movement of at least one of the anvil and the crimper, and prior to caulking of the barrel portion, pushes the cable outward while coming into contact with the cable and being applied with pressing force so as to bring the core wire into contact with a base surface of the barrel portion; and a regulating part which interferes with the pressing part which brings the core wire into contact with the base surface, and regulates pushing out the cable by the pressing part.

### INCORPORATION BY REFERENCE

This application a Divisional of U.S. patent application Ser. No. 17/954,774 filed Sep. 28, 2022, and is based on and claims the benefit of priority from Japanese Patent application No. 2021-160568 filed on Sep. 30, 2021, the entire contents of which are incorporated herein by reference.

### TECHNICAL FIELD

The present invention relates to a terminal crimping apparatus which crimps a terminal to a core wire of a cable.

### BACKGROUND

A terminal crimping apparatus in which a core wire crimper is provided with a core wire pressing part bent downward in an L-shape is disclosed. When a barrel portion is clamped between a core wire anvil and a core wire crimper and caulked, the tip end portion (the lower end portion) of the core wire pressing part presses the core wire protruding forward from the barrel portion. This prevents the tip end portion of the core wire from jumping up due to the caulking process of the barrel portion.

However, in the above-described terminal crimping apparatus, the case where the core wire is not properly accommodated inside the barrel portion has not been sufficiently considered. For example, if the barrel portion is caulked in a state where the core wire of the cable floats from the base surface of the core wire barrel portion, a part or all of the core wire cannot be enclosed, and there is a possibility of a crimping failure.

As a countermeasure to the above problem, it is considered that the core wire barrel portion of the terminal is lengthened (lengthened from the base surface) so that the core wire floating from the base surface is caulked while being enclosed. However, the extremely long core barrel portion cannot be properly caulked, and there is still a possibility of a crimping failure.

As another countermeasure to the above problem, as shown in FIG. 9, it is conceivable to provide a pressing part 35 for pushing the cable 5 to bring the core wire 50 into contact with the base surface 41B of the core wire barrel portion 41 of the terminal 4. However, if the pressing part 35 pushes the cable 5 excessively, the cable 5 is bent around the contact portion of the pressing part 35, and the core wire 50 may be jumped up from the base surface 41B. In this case, as in the above problem, the core wire barrel portion 41 may be caulked in a state that the core wire 50 floats from the base surface 41B, and there is a possibility of a crimping failure.

### SUMMARY OF THE INVENTION

In accordance with one aspect of the present disclosure, a terminal crimping apparatus clamps a barrel portion of a terminal between an anvil and a crimper and caulks the barrel portion so as to enclose a core wire of a cable with the barrel portion. The terminal crimping apparatus comprising: a pressing part which is provided adjacent to the crimper side by side, is capable of separating from and approaching to the cable by movement of at least one of the anvil and the crimper in a separating and approaching direction, and prior to caulking of the barrel portion, pushes the cable outward while coming into contact with the cable and being applied with pressing force so as to bring the core wire into contact with a base surface of the barrel portion; and a regulating part which interferes with the pressing part which brings the core wire into contact with the base surface, and regulates pushing out the cable by the pressing part.

The other features and advantages of the present disclosure will become more apparent from the following description. In the detailed description, reference is made to the accompanying drawings, and preferred embodiments of the present disclosure are shown by way of example in the accompanying drawings.

### BRIEF DESCRIPTION OF THE DRAWINGS

FIG. 1 is a perspective view showing a terminal crimping apparatus according to one embodiment of the present invention.

FIG. 2A is a perspective view showing a terminal and a cable (before crimping) used in the terminal crimping apparatus according to the embodiment of the present invention.

FIG. 2B is a perspective view showing the terminal and the cable (after crimping) used in the terminal crimping apparatus according to the embodiment of the present invention.

FIG. 3 is a disassembled perspective view showing the terminal crimping apparatus according to the embodiment of the present invention.

FIG. 4 is a flowchart explaining a terminal crimping method according to the embodiment of the present invention.

FIG. 5 is a sectional view explaining the terminal crimping apparatus at a push-out process (an early stage) according to the embodiment of the present invention.

FIG. 6 is a sectional view explaining the terminal crimping apparatus at the push-out process (a later stage) according to the embodiment of the present invention.

FIG. 7 is a sectional view explaining the terminal crimping apparatus at a pushing regulating process and a terminal dividing process according to the embodiment of the present invention.

FIG. 8 is a sectional view explaining the terminal crimping apparatus at a crimping process according to the embodiment of the present invention.

FIG. 9 is a sectional view explaining a conventional terminal crimping apparatus in a state where a pressing part pushes a cable downward.

### DETAILED DESCRIPTION

Hereinafter, with reference to the attached drawings, one embodiment of the present invention will be described. In each drawing, “X1” indicates “left”, “X2” indicates “right”, “Y1” indicates “front”, “Y2” indicates “rear”, “Z1” indicates “upper”, and “Z2” indicates “lower”. Although the terms indicating directions and positions are used in the specification, these terms are used for convenience for explanation and do not limit the scope of the invention.

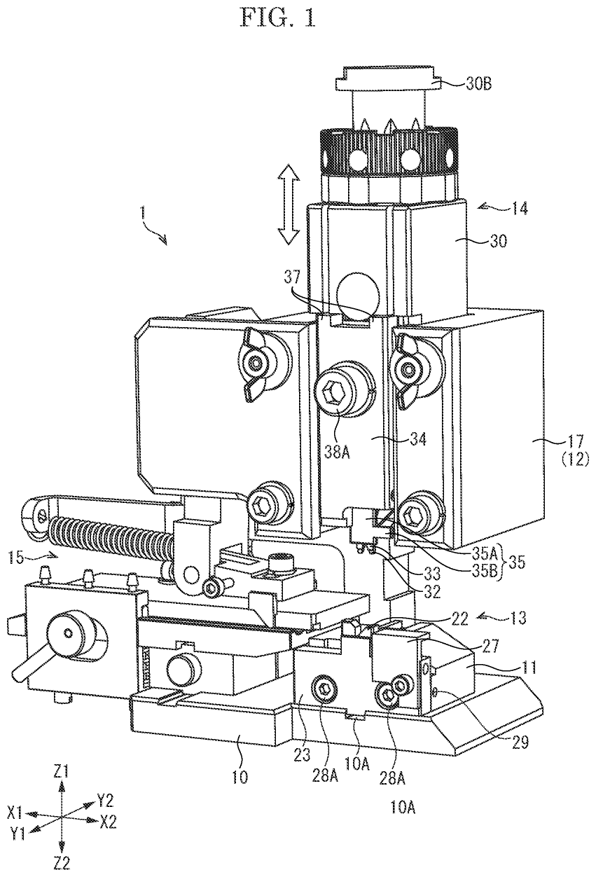

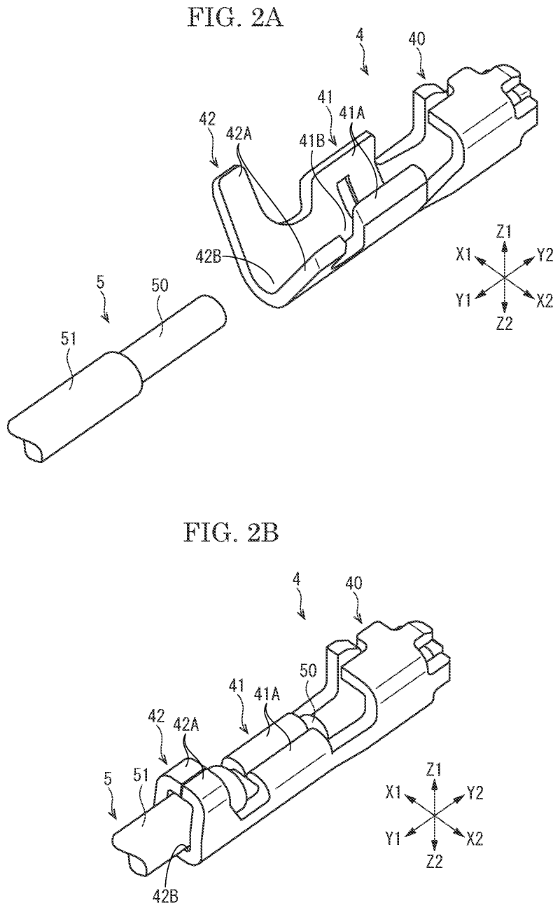

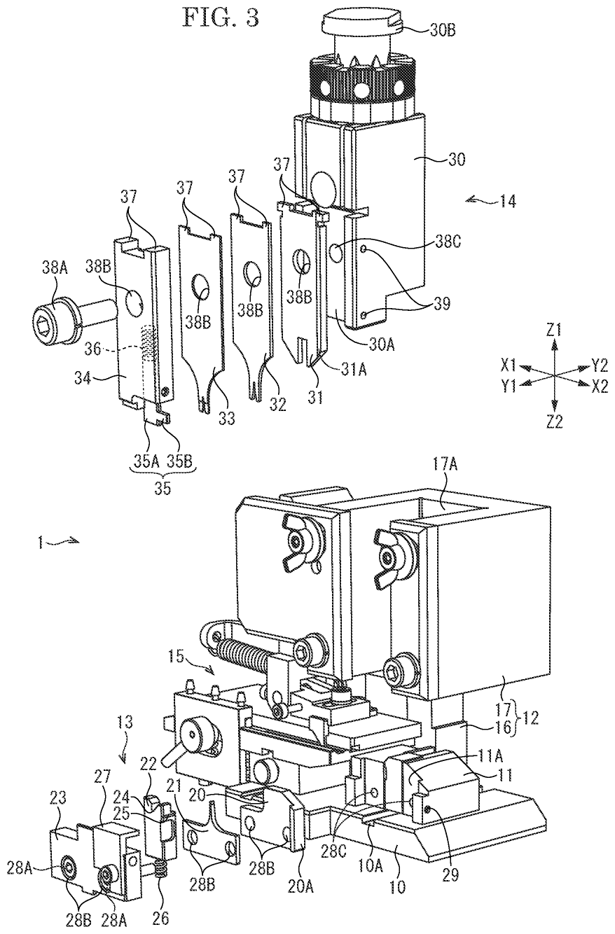

With reference to FIG. 1 to FIG. 3, a terminal crimping apparatus 1 will be described. FIG. 1 is a perspective view showing the terminal crimping apparatus 1. FIG. 2A is a perspective view showing a terminal 4 and a cable 5 before crimping. FIG. 2B is a perspective view showing the terminal 4 and the cable 5 after crimping. FIG. 3 is a disassembled perspective view showing the terminal crimping apparatus 1.

As shown in FIG. 1, the terminal crimping apparatus 1 is provided with a ram 14 configured to separate from and approach to a lower die part 13 provided on a pedestal 10. Although the details will be described later, the lower die part 13 is provided with an anvil 21, and the ram 14 is provided with a core wire crimper 32 and a coating crimper 33. The terminal crimping apparatus 1 is an apparatus which clamps barrel portions 41, 42 of a terminal 4 between the anvil 21 and the crimpers 32, 33 and caulks the barrel portions 41, 42 so as to enclose a core wire 50 of a cable 5 with the barrel portions 41, 42. That is, the terminal crimping apparatus 1 crimps the terminal 4 to the core wire 50 of the cable 5. Prior to the detailed description of the terminal crimping apparatus 1, the terminal 4 and the cable 5 will be described.

[Terminal] As shown in FIG. 2A, the terminal 4 has a connecting portion 40, the core wire barrel portion 41, and the coating barrel portion 42. The terminal 4 is integrally molded of metal material. The connecting portion 40 is formed in an approximately rectangular cylindrical shape with front and rear ends opened, and is connected to a mating terminal (not shown). The core wire barrel portion 41 has a pair of core wire barrel pieces 41A stood at a position separated forward from the connecting portion 40. The coating barrel portion 42 has a pair of coating barrel pieces 42A stood at a position separated forward from the core wire barrel portion 41. Both the barrel portions 41, 42 are formed in an approximately U-shape when viewed from the front side (in an axial direction). The base surface 41B of the core wire barrel portion 41 and the base surface 42B of the coating barrel portion 42 form the same plane surface.

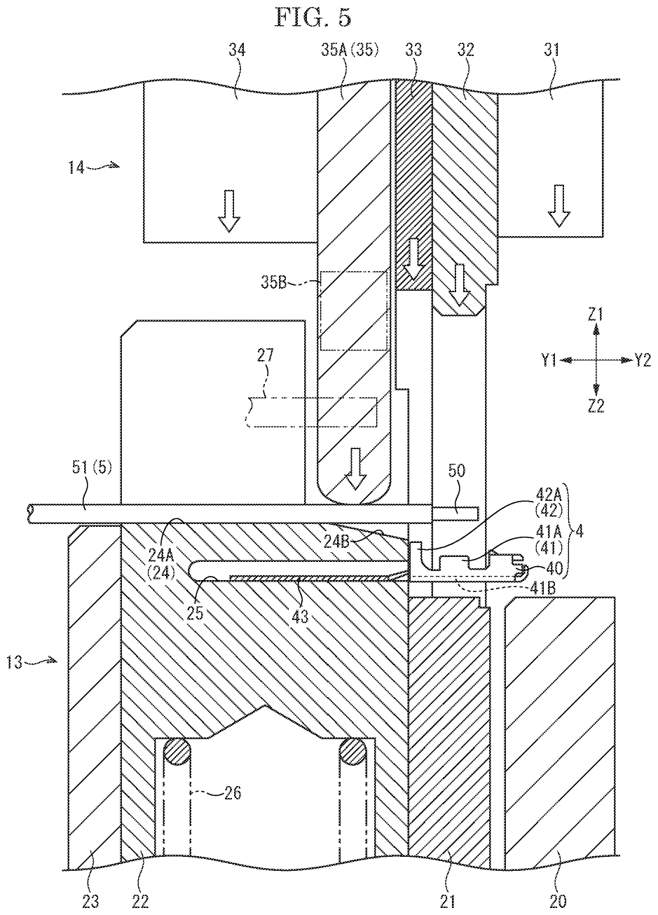

A plurality of the terminals 4 are connected to a carrier 43 formed in a tape-like shape (a strip-like shape) at equal intervals (see FIG. 5). Specifically, each terminal 4 is connected to the carrier 43 via a joint portion (not shown) extending from the base surface 42B of the coating barrel portion 42.

[Cable] As shown in FIG. 2A, the cable 5 has a core wire 50 made of conductor and a coated part 51 made of insulator and coating the core wire 50. On the tip end side of the cable 5, the coated part 51 is striped, and the core wire 50 is exposed. The core wire 50 is placed on the base surface 41B of the core wire barrel portion 41, and the tip end portion of the coated part 51 connected to the core wire 50 is placed on the base surface 42B of the coating barrel portion 42. As shown in FIG. 2B, the pair of core wire barrel pieces 41A are bent inward (the core wire barrel portion 41 is caulked), so that the terminal 4 is crimped to the core wire 50. The pair of coating barrel pieces 42A are bent inward (the coating barrel portion 42 is caulked), so that the terminal 4 is crimped to the tip end portion of the coated part 51 connected to the core wire 50.

[Structure of Terminal Crimping Apparatus] Next, the terminal crimping apparatus 1 will be described in detail. As shown in FIG. 3, the terminal crimping apparatus 1 includes the pedestal 10, a lower die mounting part 11, an upper die mounting part 12, the lower die part 13, the ram 14, and a terminal conveying part 15.

<Pedestal, Lower Die Mounting Part, Upper Die Mounting Part> The pedestal 10 is formed in an approximately flat plate shape. The lower die mounting part 11 supports the lower die part 13, and the upper die mounting part 12 supports the ram 14 in a liftable and lowerable manner. The lower die mounting part 11 is formed in an approximately block like shape, and fixed on the right front portion of the upper surface of the pedestal 10. On the front surface of the lower die mounting part 11, a lower die holding groove 11A in which the lower die part 13 is fitted is formed. The upper die mounting part 12 has a strut 16 stood on the pedestal 10 on the rear side of the lower die mounting part 11, and a lifting supporting part 17 connected to the upper portion of the strut 16. The lifting supporting part 17 extends from the strut 16 so as to cover above the lower die mounting part 11. The lifting supporting part 17 has a lifting groove 17A with the front side opened, and is formed in an approximately U-shape in a plan view. In the lifting groove 17A, the ram 14 is fitted in a liftable and lowerable manner.

<Lower Die Part> The lower die part 13 includes a shear plate 20, the anvil 21, a cutoff punch 22 and a cutoff die 23.

(Shear Plate, Anvil) The shear plate 20 is formed in an approximately flat plate shape capable of being fitted in the lower die holding groove 11A of the lower die mounting part 11. In the right end portion of the shear plate 20, a screw receiving portion 20A bent forward is formed. The anvil 21 is formed in a shape in which one sharp projecting portion is projected upward from an approximately flat plate-shaped lower portion.

(Cutoff Punch) The cutoff punch 22 is formed in a block like shape narrower than the shear plate 20 and the anvil 21 in the left-and-right direction. On the upper surface of the cutoff punch 22, an arrangement groove 24 in which the cable 5 is arranged is formed. In front of the arrangement groove 24, a horizontal surface 24A is formed, and on the rear side of the arrangement groove 24, an inclined surface 24B inclined downward (a push-out direction of the pressing part 35 described later) is formed (see FIG. 5). On the upper portion of the rear surface of the cutoff punch 22, a passing groove 25 extending forward in an approximately horizontal direction is formed. In the passing groove 25, the carrier 43 connected to the plurality of terminals 4 is passed, and the carrier 43 is supported in a movable manner from the right to the left along the passing groove 25 (see FIG. 5).

The cutoff punch 22 is biased upward by a push-up member 26 (pushed upward) (see also FIG. 5). The push-up member 26 is a compression coil spring, for example, and is provided between the lower surface of the cutoff punch 22 and the pedestal 10. The lower end portion of the push-up member 26 is fitted into the pedestal groove 10A formed in the pedestal 10. The push-up member 26 is not limited to a compression coil spring, and may be made of elastic material such as rubber, for example.

(Cutoff Die) The cutoff die 23 as an example of the supporting part is formed in an approximately flat plate shape wider than the shear plate 20 and the anvil 21 in the left-and-right direction. A regulating part 27 is fixed (supported) on the right side portion of the front surface of the cutoff die 23. The upper portion of the regulating part 27 is bent rearward, and the regulating part 27 is formed in an inverted L-shape when viewed from the side surface.

The shear plate 20, the anvil 21 and the cutoff die 23 each has a pair of through holes 28B for penetrating a pair of mounting screws 28A. A pair of female screw portions 28C to which the pair of mounting screws 28A are screwed are formed in the lower die mounting part 11.

[Assembling of Lower Die Part] Next, an example of a procedure for assembling the lower die part 13 will be described. First, an operator fits the shear plate 20 into the lower die holding groove 11A of the lower die mounting part 11, and fits the anvil 21 between the left inner side surface of the lower die holding groove 11A and the inner side surface of the screw receiving portion 20A of the shear plate 20. At this time, the operator presses the lower end portions of the shear plate 20 and the anvil 21 against the upper surface of the pedestal 10. Further, an adjustment screw 29 capable of coming into contact with the screw receiving portion 20A of the shear plate 20 is screwed in the right side surface of the lower die mounting part 11, and the operator screws the adjustment screw 29 to press the shear plate 20 holding the anvil 21 against the left inner side surface of the lower die holding groove 11A. Thus, the anvil 21 and the others can be positioned at a predetermined position.

Subsequently, the operator superimposes the cutoff punch 22 on the front surface of the anvil 21 and superimposes the cutoff die 23 on the front surface of the cutoff punch 22. Finally, the operator screws the pair of mounting screws 28A through the pair of through holes 28B to the pair of female screw portions 28C of the lower die mounting part 11. The cutoff die 23 is integrated with the anvil 21 across the cutoff punch 22.

As described above, the shear plate 20, the anvil 21, the cutoff punch 22 and the cutoff die 23 are sequentially stacked from the rear to the front to form the lower die part 13 (see FIG. 1). In this state, the horizontal surface 24A of the arrangement groove 24 of the cutoff punch 22 is arranged on substantially the same plane as the upper end surface of the cutoff die 23 (see FIG. 5). The upper end surface of the anvil 21 is located below the lower end of the inclined surface 24B of the arrangement groove 24 (see FIG. 5). That is, the upper end portion (the tip end portion) of the cutoff die 23 projects upward (toward the crimpers 32, 33) from the upper end portion (the tip end portion) of the anvil 21. The passing groove 25 of the cutoff punch 22 is located slightly above the upper end surface of the anvil 21 (see FIG. 5).

<Ram> As shown in FIG. 3, the ram 14 includes a lifting supporting body 30, a spacer 31, the core wire crimper 32, the coating crimper 33, an actuator 34 and the pressing part 35.

(Lifting Supporting Body) The lifting supporting body 30 is formed in an approximately rectangular columnar shape. The lifting supporting body 30 is fitted into the lifting groove 17A of the upper die mounting part 12 (the lifting supporting part 17), and is supported in a movable state upward and downward. A drive input part 30B connected to a driving source (not shown) such as an electric motor through a drive transmission mechanism (not shown) is provided on the upper portion of the lifting supporting body 30. The lifting supporting body 30 reciprocates (lifts and lowers) in the upper-and-lower direction by receiving a driving force from the driving source. An upper die holding groove 30A for fitting the spacer 31 and the others is formed on the lower portion of the front surface of the lifting supporting body 30.

(Spacer, Core Wire Crimper, Coating Crimper) The spacer 31 is formed in an approximately flat plate shape capable of fitting into the upper die holding groove 30A of the lifting supporting body 30. A screw receiving portion 31A bent forward is formed on the right end portion of the spacer 31. The core wire crimper 32 is formed in a shape in which one sharp projecting portion is projected downward from the upper portion formed in an approximately flat plate shape. The tip end portion (the lower end portion) of the sharp projecting portion of the core wire crimper 32 is bifurcated into a recess shape. The coating crimper 33 has substantially the same shape as the above-described core wire crimper 32.

(Actuator, Pressing Part) The actuator 34 is formed in an approximately flat plate shape thicker than the crimpers 32 and 33. A space in which the pressing part 35 can be stored is formed in the lower portion of the actuator (not shown).

(Pressing Part) The pressing part 35 has a pressing portion 35A formed in an approximately rectangular flat plate shape and an interference projecting portion 35B projecting rightward from the lower portion of the pressing portion 35A, and is formed in an approximately L-shape. The upper portion of the pressing portion 35A is stored in the space formed in the lower portion of the actuator 34, and the lower portion of the pressing portion 35A and the interference projecting portion 35B are exposed to the lower portion of the actuator 34. The pressing part 35 is supported by the actuator 34 through a biasing member 36. The biasing member 36 is a compression coil spring, for example, and is provided between the upper end of the pressing portion 35A and the top surface (not shown) of the space of the actuator 34. The pressing part 35 is biased downward by the biasing member 36 (pushed downward). The biasing member 36 is not limited to a compression coil spring, but may be elastic material such as rubber.

In the right and left portions of the upper end portion of each of the spacer 31, the core wire crimper 32, the coating crimper 33 and the actuator 34, a pair of positioning projections 37 is formed. The spacer 31, the core wire crimper 32, the coating crimper 33 and the actuator 34 each has a through hole 38B through which a mounting screw 38A is passed. The lifting supporting body 30 has a male screw portion 38C to which the mounting screw 38A is screwed.

[Assembling of Ram] Next, an example of a procedure for assembling the ram 14 will be described. First, the operator fits the spacer 31 into the upper die holding groove 30A of the lifting supporting body 30, and fits the core wire crimper 32 between the left inner side surface of the upper die holding groove 30A and the inner side surface of the screw receiving portion 31A of the spacer 31. At this time, the operator presses the pairs of positioning projections 37 of the spacer 31 and the core wire crimper 32 against the upper inner surface of the upper die holding groove 30A. An adjustment screw 39 capable of coming into contact with the screw receiving portion 31A of the spacer 31 is screwed to the right side surface of the lifting supporting body 30, and the operator screws the adjustment screw 39 to press the spacer 31 holding the core wire crimper 32 against the left inner side surface of the upper die holding groove 30A. Thus, the core wire crimper 32 and the others can be positioned at a predetermined position.

Subsequently, the operator superimposes the coating crimper 33 on the front surface of the core wire crimper 32, presses the left end surface of the coating crimper 33 against the left inner side surface of the upper die holding groove 30A, and presses the pair of positioning projections 37 of the coating crimper 33 against the upper inner surface of the upper die holding groove 30A. Thus, the coating crimper 33 is positioned. Finally, the operator superimposes the actuator 34 on the front surface of the coating crimper 33, and screws the mounting screw 38A through the through hole 38B to the male screw portion 38C of the lifting supporting body 30. The actuator 34 is integrated with both the crimpers 32, 33, and the pressing part 35 is disposed adjacent to both the crimpers 32, 33 side by side.

As described above, the spacer 31, the core wire crimper 32, the coating crimper 33 and the actuator 34 are fixed to the lifting supporting body 30 in a state where they are sequentially stacked from the rear to the front, to form the ram 14 (see FIG. 1). The lifting supporting body 30 of the ram 14 is mounted in the lifting groove 17A of the upper die mounting part 12. The actuator 34 and the pressing part 35 can separate from and approach to the cable 5 by the upward and downward movement (the movement in the separating and approaching direction) of the lifting supporting body 30 to which both the crimpers 32 and 33 and the others are mounted. The position of the ram 14 lifted to the uppermost position is defined as the initial position.

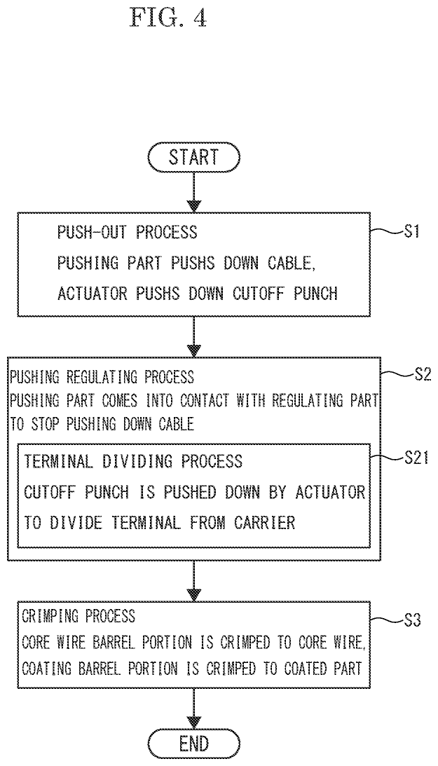

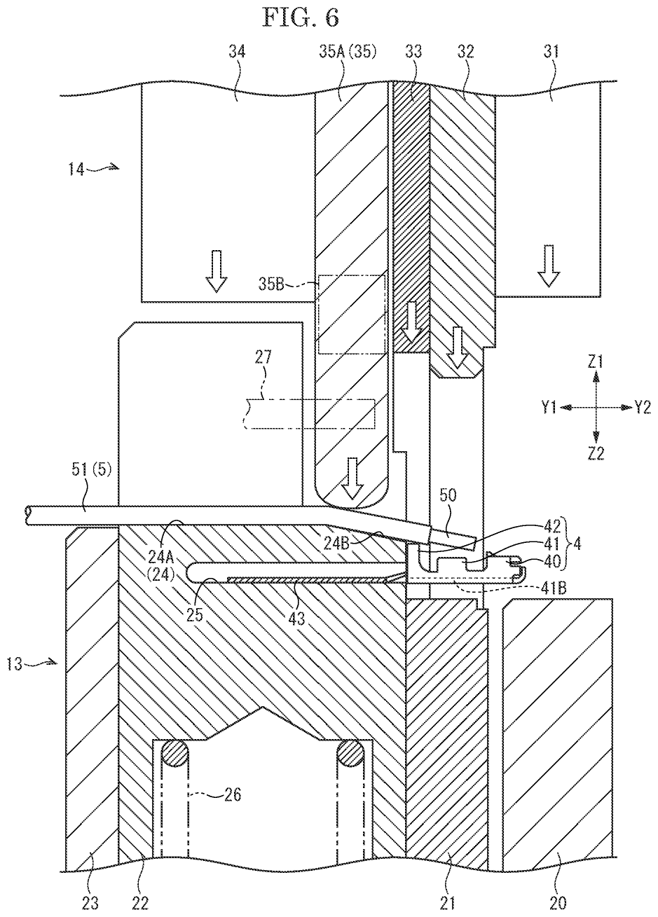

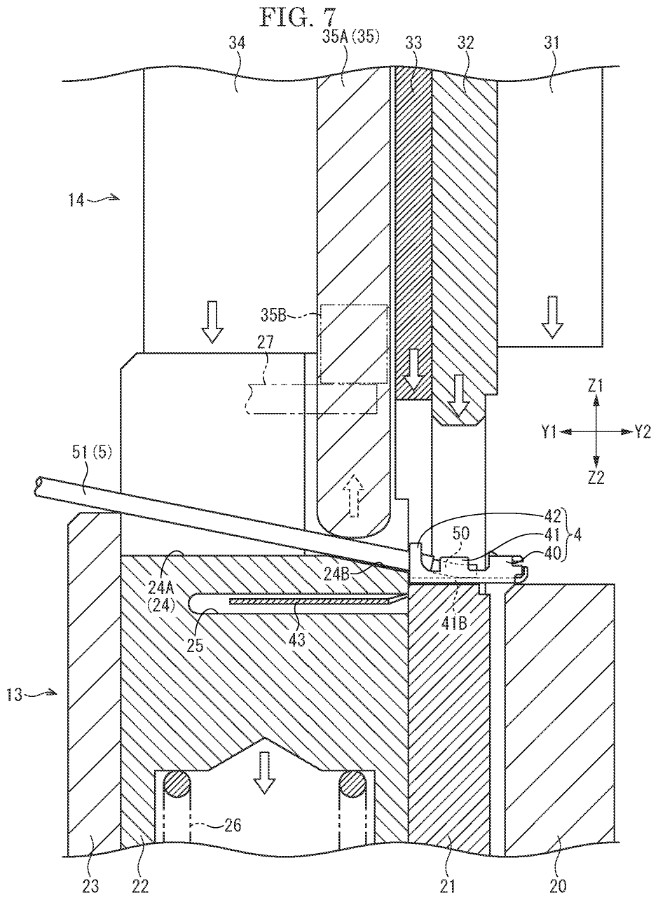

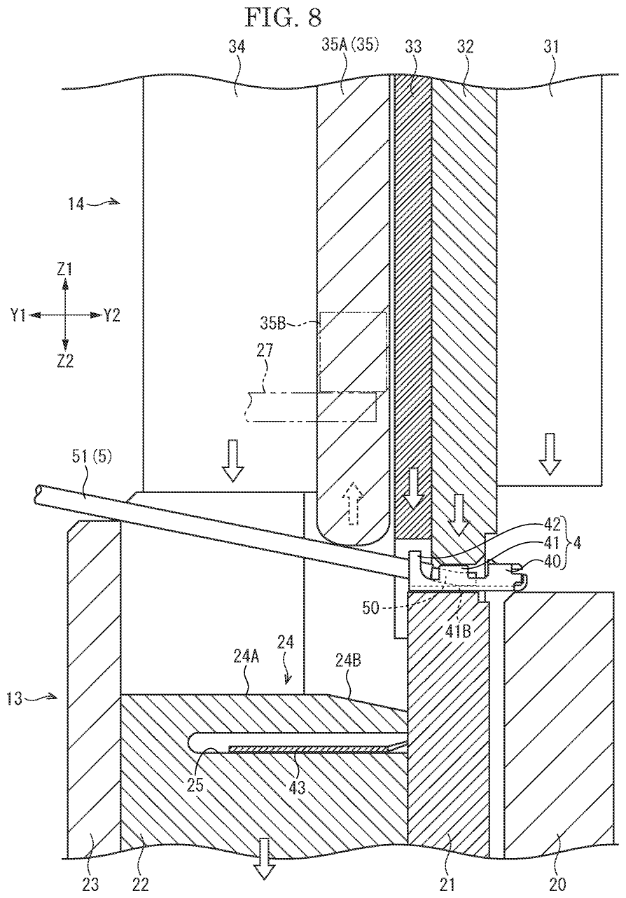

In a state where the ram 14 is mounted on the upper die mounting part 12, the concave upper inner surface of the coating crimper 33 is positioned above the concave upper inner surface of the core wire crimper 32 by an approximately thickness of the coated part 51 (see FIG. 5). Both the crimpers 32 and 33 (the concave upper inner surfaces) face the anvil 21 (the upper end surface of the anvil) across the space (see FIG. 5). That is, the sharp projecting portion of the anvil 21 can enter the concave portions of the crimpers 32 and 33. The lower end surface of the actuator 34 is located above the concave upper inner surface of the coating crimper 33 (see FIG. 5). The lower end surface of the pressing part 35 (the pressing portion 35A) is located below the concave upper inner surface of the core wire crimper 32 (see FIG. 5). The actuator 34 (its lower end surface) faces the cutoff punch 22 (its upper end surface) provided adjacent to the anvil 21 side by side across the space (see FIG. 1). The pressing portion 35A (its lower end surface) faces the inclined surface 24B of the arrangement groove 24 of the cutoff punch 22 (see FIG. 5). The interference projecting portion 35B (its lower end surface) faces the regulating part 27 (its upper end surface) fixed to the cutoff die 23 (see FIG. 1 and FIG. 5).

<Terminal Conveying Part> As shown in FIG. 1 and FIG. 3, the terminal conveying part 15 is disposed on the left side of the lower die part 13. The terminal conveying part 15 has a function of feeding the terminal 4 (the carrier 43) toward the lower die part 13 by being applied with driving force from a conveying driving source (not shown). The carrier 43 is intermittently (gradually) moved rightward while being guided by the passing groove 25 of the cutoff punch 22, so that the terminal 4 connected to the carrier 43 is fed on the tip end surface of the anvil 21.

[Terminal Crimping Method] Next, with reference to FIG. 4 to FIG. 8, a terminal crimping method using the terminal crimping apparatus 1, in other words, a work in which the terminal 4 is crimped to the cable 5 (the core wire 50) (a crimping work) will be described. FIG. 4 is a flowchart explaining the terminal crimping method. FIG. 5 is a sectional view explaining a push-out process S1 (the early stage). FIG. 6 is a sectional view explaining the push-out process S1 (the later stage). FIG. 7 is a sectional view explaining a pushing regulating process S2 and a terminal dividing process S21. FIG. 8 is a sectional view explaining a crimping process S3.

As shown in FIG. 4, the terminal crimping method includes the push-out process S1, the pushing regulating process S2 and the crimping process S3. The pushing regulating process S2 includes the terminal dividing process S21.

In the push-out process S1, prior to the caulking of both the barrel portions 41 and 42, the pressing part 35 pushes the cable 5 downward (outward) while coming into contact with the cable 5 and being applied with pressing force such that the core wire 50 is brought into contact with the base surface 41B of the core wire barrel portion 41. In the pushing regulating process S2, the regulating part 27 which interferes with the pressing part 35 which brings the core wire 50 into contact with the base surface 41B regulates the pushing of the cable 5 by the pressing part 35. In the crimping process S3, in a state where the core wire 50 is brought into contact with the base surface 41B while the pushing of the cable 5 is regulated, the anvil 21 and both the crimpers 32 and 33 caulk the both the barrel portions 41 and 42. In the terminal dividing process S21, the cutoff punch 22 is pushed our by the actuator 34 to bring the core wire 50 into contact with the base surface 41B and to divide the terminal 4 placed on the tip end portion of the anvil 21 from the carrier 43.

The terminal conveying part 15 feeds the terminal 4 on the tip end surface of the anvil 21, and the operator inserts the cable 5 whose core wire 50 is exposed, in the arrangement groove 24 of the cutoff punch 22 (see FIG. 5). Since the passing groove 25 is located above the upper end surface of the anvil 21, the terminal 4 (both the barrel portions 41 and 42) extending from the carrier 43 supported by the passing groove 25 is disposed in a state where it slightly floats from the upper end surface of the anvil 21 (see FIG. 5). The cable 5 is placed on the horizontal surface 24A of the arrangement groove 24, and the tip end side portion of the cable 5 containing the core wire 50 extends approximately horizontally and is disposed in a state where it floats slightly from both the barrel portions 41 and 42 (see FIG. 5).

When the operator drives the driving source, the ram 14 starts to be lowered. As shown in FIG. 5, the ram 14 is lowered until the lower end surface of the pressing part 35 (the pressing portion 35A) comes into contact with the cable 5 (the coated part 51). The actuator 34 is separated upward (does not come into contact with) from the cutoff punch 22.

<Push-out Process> As the ram 14 is lowered further, as shown in FIG. 6, the pressing part 35 pushes the tip end side portion (the rear side portion) of the cable 5 downward (the push-out process S1). At this time, the pressing part 35 is pushed into the actuator 34 while slightly compressing the biasing member 36 by the reaction force (the pressing force) of the cable 5. The tip end side portion of the cable 5 is pressed by the pressing part 35 and bent downward at the boundary portion between the horizontal surface 24A and the inclined surface 24B of the arrangement groove 24. The tip end side portion of the cable 5 is inclined along the inclined surface 24B, and the core wire 50 approaches to the core wire barrel portion 41. The actuator 34 is not in contact with the cutoff punch 22.

As the ram 14 is further lowered, the pressing part 35 pushes the tip end side portion of the cable 5 downward, and the lower end surface of the actuator 34 comes into contact with the upper end surface of the cutoff punch 22 (see FIG. 7). The actuator 34 pushes the cutoff punch 22 downward while compressing the push-up member 26. As the cutoff punch 22 is lowered, the terminal 4 connected to the carrier 43 is also lowered, and the base surfaces 41B, 42B of the barrel portions 41, 42 come into contact with the tip end (the upper end) of the anvil 21 (see FIG. 7). The cable 5 is separated from the horizontal surface 24A of the arrangement groove 24, and is extended obliquely between the upper end portion of the cutoff die 23 and the inclined surface 24B in a state where the bending is substantially eliminated (see FIG. 7). The core wire 50 further approaches to the core wire barrel portion 41. As described above, the cutoff punch 22 is capable of separating from and approaching to the cable 5 by the upward and downward movement (the movement in the separating and approaching direction) of the lifting supporting body 30 to which both the crimpers 32, 33 and the others are mounted.

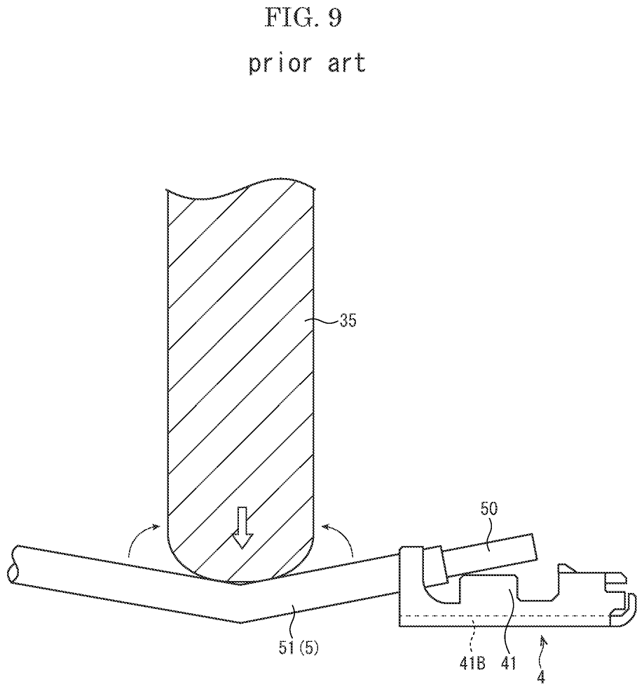

By the way, if the pressing part 35 continues to be lowered together with the actuator 34 and the cable 5 continues to be pushed downward, the cable 5 may be bent around the contact portion of the pressing part 35, and the core wire 50 may be jumped up from the base surface 41B of the core wire barrel portion 41 (see FIG. 9). In a state where the core wire 50 floats from the base surface 41B, the core wire barrel portion 41 may not be properly caulked. Therefore, the terminal crimping apparatus 1 (the terminal crimping method) according to the present embodiment is configured to regulate excessive pushing down of the cable 5 by the pressing part 35.

<Pushing Regulating Process> As the ram 14 is further lowered, as shown in FIG. 7, the interference projecting portion 35B of the pressing part 35 comes into contact with the regulating part 27 fixed to the cutoff die 23, and the pressing part 35 stops the pushing down of the cable 5 (the pushing regulating process S2). The pressing part 35 is pushed into the actuator 34 by the reaction force from the regulating part 27 while compressing the biasing member 36. In other words, the pressing part 35 is pushed upward relative to the actuator 34 pushing down the cutoff punch 22 (see the broken line arrow in FIG. 7). In the pushing regulating process S2, the actuator 34 further pushes the cutoff punch 22 downward.

(Terminal Dividing Process) The cable 5 in which the pushing down by the pressing part 35 is regulated is disposed between the terminal 4 disposed on the tip end portion of the anvil 21 and the tip end portion of the cutoff die 23, and is in an inclined posture in which the core wire 50 is brought into contact with the base surface 41B. When the passing groove 25 of the cutoff punch 22 is moved below the upper end surface of the anvil 21, the terminal 4 (both the barrel portions 41, 42) is placed on the upper end surface of the anvil 21, and is divided from the carrier 43 by a shearing force acting on the joint portion with the carrier 43 (the terminal dividing process 21).

<Crimping Process> As the ram 14 is further lowered, as shown in FIG. 8, the actuator 34 pushes the cutoff punch 22 downward further while the pressing part 35 stopped, and the anvil 21 enters the recesses of both the crimpers 32 and 33 across both the barrel portions 41, 42 (the crimping process S3). The core wire barrel portion 41 is clamped between the anvil 21 and the core wire crimper 32, the core wire barrel pieces 41A are folded inward along the recess of the core wire crimper 32 so as to be crimped to the core wire 50 contacting with the base surface 41B (see FIG. 2B). The coating barrel portion 42 is clamped between the anvil 21 and the coating crimper 33, and the coating barrel pieces 42A are fold inward along the recess of the coating crimper 33 so as to be crimped to the coated part 51 on the base surface 42B (see FIG. 2B).

As described above, the terminal 4 is crimped to the core wire 50 of the cable 5 (see FIG. 2B). When the terminal crimping work is completed, the ram 14 is lifted to be separated from the lower die part 13. As the ram 14 is lifted, both the crimpers 32 and 33 are separated from the terminal 4 on the anvil 21, the pressing part 35 is separated from the cable 5 while being pushed outward by the biasing member 36, and the actuator 34 is separated from the cutoff punch 22. The operator draws back the cable 5 to which the terminal 4 is crimped.

The above-described terminal crimping apparatus 1 (the terminal crimping method) according to the present embodiment is configured such that prior to the caulking of the core wire barrel portion 41, the pressing part 35 pushes the cable 5 downward (outward) while coming into contact with the cable 5 and being applied with the pressing force (the reaction force from the cable 5) so that the core wire 50 is brought into contact with the base surface 41B of the core wire barrel portion 41. Further, it is configured such that the regulating part 27 interferes with the pressing part 35 which brings the core wire 50 into contact with the base surface 41B, and regulates the pushing down the cable 5 by the pressing part 35. According to the configurations, it becomes possible to stop the pressing part 35 at a position where the core wire 50 is brought into contact with the base surface 41B of the core wire barrel portion 41, so that the pressing part 35 is prevented from pushing the cable 5 excessively. Therefore, it becomes possible to caulk the core wire barrel portion 41 with the core wire 50 coming into contact with the base surface 41B of the core wire barrel portion 41. As a result, the terminal 4 can be crimped to the core wire 50 properly and the crimping failure can be suppressed.

In the terminal 4 used in the terminal crimping apparatus 1 according to the present embodiment, since the base surfaces 41B, 42B of both the barrel portions 41, 42 are made to be the same plane surface, when the cable 5 is placed on the base surfaces 41B, 42B with a horizontal posture, the core wire 50 floats from the base surface 41B by the thickness of the coated part 51. On the other hand, in the terminal crimping apparatus 1 (the terminal crimping method) according to the present embodiment, the cable 5 disposed between the terminal 4 supported by the anvil 21 and the tip end portion of the cutoff die 23 is inclined so as to press the core wire 50 against the base surface 41B of the core wire barrel portion 41 (see FIG. 7 and FIG. 8). According to this configuration, the core wire barrel portion 41 can be caulked with the core wire 50 firmly in contact with the base surface 41B. Thus, the terminal 4 can be crimped to the core wire 50 properly.

Further, according to the terminal crimping apparatus 1 (the terminal crimping method) according to the present embodiment, the amount of pushing of the pressing part 35 against the actuator 34 can be adjusted by the elastic deformation of the biasing member 36. Thereby, it becomes possible to suppress excessive pushing down the cable 5 by the pressing part 35 effectively, and the bending of the cable 5 (the jumping up of the core wire 50) can be prevented. In addition, the terminal 4 can be divided from the carrier 43 while being pressed by the core wire 50. Thus, the terminal 4 can be prevented from coming off (falling) from the anvil 21 by the impact generated when it is divided from the carrier 43.

In the terminal crimping apparatus 1 according to the present embodiment, the lower die part 13 including the anvil 21 and the others is fixed, and the ram 14 including both the crimpers 32 and 33 (the lifting supporting body 30) is moved upward and downward, but the present invention is not limited thereto. For example, the ram 14 including both the crimpers 32 and 33 may be fixed, and the lower die part 13 supporting the terminal 4 and the cable 5 may be moved upward and downward (not shown). That is, the actuator 34, the pressing part 35 and the cutoff punch 22 may be made to be separatable and approachable from and to the cable 5 by the upward and downward movement of the lower die part 13 including the anvil 21 and the others (the movement in the separating and approaching direction). Alternatively, both the ram 14 (both the crimpers 32, 33) and the lower die part 13 (the anvil 21) may be moved upward and downward (not shown).

Further, the terminal crimping apparatus 1 according to the present embodiment is configured such that the ram 14 is moved upward and downward (lifted and lowered), but the present invention is not limited thereto. For example, the above-described terminal crimping apparatus 1 may be put down sideways, and the ram 14 may be moved leftward and rightward (or forward and rearward) (not shown). In this case, the ram 14 may be fixed and the lower die part 13 may be moved, or both the ram 14 and the lower die part 13 may be moved (not shown).

In the terminal crimping apparatus 1 according to the present embodiment, the pressing part 35 is supported by the actuator 34 through the biasing member 36, but the present invention is not limited thereto. The biasing member 36 may be omitted, and the pressing part 35 may push out the cable 5 by its own weight (not shown).

Further, in the terminal crimping apparatus 1 according to the present embodiment, in the crimping process S3, the cable 5 is in a posture inclined downward from the front to the rear, but the present invention is not limited thereto. For example, the cable 5 may be in a horizontal posture substantially parallel with the terminal 4 (not shown). In this case, the inclined surface 24B may be omitted from the arrangement groove 24 of the cutoff punch 22. In addition, the positions of the pressing part 35 and the regulating part 27 are preferably adjusted so that the cable 5 is in a horizontal posture in the crimping process S3. As described above, in the case where the base surfaces 41B and 42B of the barrel portions 41 and 42 of the terminal 4 are on the same plane surface, when the cable 5 is in a horizontal posture, the core wire 50 floats from the base surface 41B by the thickness of the coated part 51, but when the cable 5 is pressed by the pressing part 35 and the core wire 50 is in a horizontal posture close to the base surface 41B, it is considered that proper crimping can be performed. That is, the pressing part 35 “pushes out the cable 5 so as to bring the core wire 50 into contact with the base surface 41B” in the specification does not necessarily require that the core wire 50 be in contact with the base surface 41B, but means that the core wire 50 is so close as to come into contact with the base surface 41B.

In the terminal 4 used in the terminal crimping apparatus 1 according to the present embodiment, the base surfaces 41B and 42B of both the barrel portions 41 and 42 are made to be on the same plane surface, but the present invention is not limited thereto, and for example, a step corresponding to the thickness of the coated part 51 may be provided between the base surfaces 41B and 42B of both the barrel portions 41 and 42 (not shown). In this case, the cable 5 may be in a horizontal posture.

In the terminal crimping apparatus 1 according to the present embodiment, one anvil 21 corresponds to the two crimpers 32, 33, but the present invention is not limited thereto, and two anvils 21 may be provided so as to correspond to both the crimpers 32, 33 (not shown).

Further, the terminal 4 used in the terminal crimping apparatus 1 according to the present embodiment has the core wire barrel portion 41 and the coating barrel portion 42, but the present invention is not limited thereto, and the coating barrel portion 42 may be omitted (not shown). In this case, the coating crimper 33 of the terminal crimping apparatus 1 may also be omitted (not shown). Further, a plurality of the terminals 4 are connected to the carrier 43, but the present invention is not limited thereto, the carrier 43 may be omitted and the individual terminals 4 may be separated (not shown). In this case, the cutoff punch 22 may omit the passing groove 25.

The description of the above embodiment shows one aspect of the terminal crimping apparatus and the terminal crimping method according to the present invention, and the technical scope of the present invention is not limited to the above embodiment. The components in the above embodiments can be appropriately replaced or combined with existing components or the like, and the description of the above embodiments does not limit the contents of the invention described in the claims.

1. A terminal crimping apparatus which clamps a barrel portion of a terminal between an anvil and a crimper and caulks the barrel portion so as to enclose a core wire of a cable with the barrel portion, the terminal crimping apparatus comprising:
a pressing part which is provided adjacent to the crimper side by side, is capable of separating from and approaching to the cable by movement of at least one of the anvil and the crimper in a separating and approaching direction, and prior to caulking of the barrel portion, pushes the cable outward while coming into contact with the cable and being applied with pressing force so as to bring the core wire into contact with a base surface of the barrel portion; and
a regulating part which interferes with the pressing part which brings the core wire into contact with the base surface, and regulates pushing out the cable by the pressing part.

2. The terminal crimping apparatus according to claim 1, further comprising:
a supporting part which is integrated with the anvil and supports the regulating part, wherein
a tip end portion of the supporting part is projected toward the crimper more than a tip end portion of the anvil, and
the cable, in which the pushing out by the pressing part is regulated, is disposed between the terminal placed on the tip end portion of the anvil and the tip end portion of the supporting part, and is in an inclined posture in which the core wire is brought into contact with the base portion.

3. The terminal crimping apparatus according to claim 2, further comprising:
an actuator which is integrated with the crimper, is capable of separating from and approaching to the cable by the movement of at least one of the anvil and the crimper in the separating and approaching direction, and supports the pressing part through a biasing member; and
a cutoff punch which faces the actuator, is disposed adjacent to the anvil side by side, is capable of separating from and approaching to the cable by the movement of at least one of the anvil and the crimper in the separating and approaching direction, and supports a carrier to which a plurality of the terminals are connected, wherein
the cutoff punch is pushed outward by the actuator to bring the core wire into contact with the base surface and to divide the terminal placed on the tip end portion of the anvil from the carrier.
